(19) United States
(12) Patent Application Publication
(10) Pub. No.: US 2026/0190073 A1
(43) Pub. Date: Jul. 2, 2026

(54) COMMUNICATION CONTROL METHOD AND USER EQUIPMENT

(71) Applicant: KYOCERA Corporation, Kyoto (JP)

(72) Inventor: Mitsutaka HATA, Yokohama-shi (JP)

(73) Assignee: KYOCERA Corporation, Kyoto (JP)

(21) Appl. No.: 19/552,122

(22) Filed: Feb. 27, 2026

Related U.S. Application Data
(63) Continuation of application No. PCT/JP2024/030516, filed on Aug. 27, 2024.

(30) Foreign Application Priority Data
Aug. 30, 2023 (JP) 2023-140121

(51) Int. Cl. H04W 64/00; H04L 41/16

(52) U.S. Cl. CPC H04W 64/00; H04L 41/16

(57) ABSTRACT

A communication control method according to an aspect is a communication control method in a mobile communication system. The communication control method includes transmitting, by a base station, a first message including a trained artificial intelligence (AI)/machine learning (ML) model to a user equipment. The communication control method includes measuring position information by the user equipment. The communication control method further includes transmitting, by the user equipment, a second message including error position information to the base station, the error position information being obtained by adding first error information indicating an error requested by a user to the position information.

### RELATED APPLICATIONS

The present application is a continuation based on PCT Application No. PCT/JP2024/030516, filed on Aug. 27, 2024, which claims the benefit of Japanese Patent Application No. 2023-140121 filed on Aug. 30, 2023. The content of which is incorporated by reference herein in their entirety.

### TECHNICAL FIELD

The present disclosure relates to a communication control method and a user equipment.

### BACKGROUND

In recent years, in the Third Generation Partnership Project (3GPP) (registered trademark; the same applies hereinafter) that is a standardization project for mobile communication systems, applying an artificial intelligence (AI) technology, in particular, a machine learning (ML) technology to wireless communication (air interface) in a mobile communication system has been studied.

### CITATION LIST

### Non-Patent Literature

Non-Patent Document 1: RP-213599, “New SI: Study on Artificial Intelligence (AI)/Machine Learning (ML) for NR Air Interface”
Non-Patent Document 2: RWS-230240, “Motivations on AI/ML-based mobility enhancement”

### SUMMARY

A communication control method according to a first aspect is a communication control method in a mobile communication system. The communication control method includes transmitting, by a network node, a first message including a trained AI/ML model to a user equipment. The communication control method includes measuring position information by the user equipment. The communication control method further includes transmitting, by the user equipment, a second message including error position information to the network node, the error position information being obtained by adding first error information indicating an error requested by a user to the position information. The communication control method further includes inferring, by the user equipment, second error information indicating an error with respect to the position information by using the AI/ML model, and transmitting, to the network node, a third message including error relationship information indicating a relationship between the first error information and the second error information.

In a second aspect, a user equipment is a user equipment in a mobile communication system. The user equipment includes a receiver configured to receive a first message including a trained AI/ML model from a network node. The user equipment includes a controller configured to measure position information. The user equipment further includes a transmitter configured to transmit, to the network node, a second message including error position information obtained by adding first error information indicating an error requested by a user to the position information. The controller infers second error information indicating an error with respect to the position information by using the AI/ML model. The transmitter transmits, to the network node, a third message including error relationship information indicating a relationship between the first error information and the second error information.

### BRIEF DESCRIPTION OF THE DRAWINGS

FIG. 1 is a diagram illustrating a configuration example of a mobile communication system according to a first embodiment.

FIG. 2 is a diagram illustrating a configuration example of user equipment (UE) according to the first embodiment.

FIG. 3 is a diagram illustrating a configuration example of a gNB (base station) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in an AI/ML technology according to the first embodiment.

FIG. 8 is a diagram illustrating an arrangement example of functional blocks of the AI/ML technology according to the first embodiment.

FIG. 9 is a diagram illustrating an operation example according to a first embodiment.

FIG. 10 is a diagram illustrating an arrangement example of functional blocks of the AI/ML technology according to the first embodiment.

FIG. 11 is a diagram illustrating an arrangement example of functional blocks of the AI/ML technology according to the first embodiment.

FIG. 12 is a diagram illustrating an arrangement example of functional blocks of the AI/ML technology according to the first embodiment.

FIG. 13 is a diagram illustrating an operation example according to the first embodiment.

FIG. 14 is a diagram illustrating an example of a configuration message according to the first embodiment.

FIG. 15 is a diagram illustrating a configuration example of functional blocks of the AI/ML technology according to the first embodiment.

FIG. 16 is a diagram illustrating an example of a use case according to the first embodiment.

FIG. 17 is a diagram illustrating an operation example according to the first embodiment.

### DESCRIPTION OF EMBODIMENTS

An object of the present disclosure is to use position information in consideration of the privacy of a user.

### First Embodiment

A mobile communication system according to a first embodiment will be described with reference to the drawings. In the description of the drawings, the same or similar parts are denoted by the same or similar reference signs.

### Configuration of Mobile Communication System

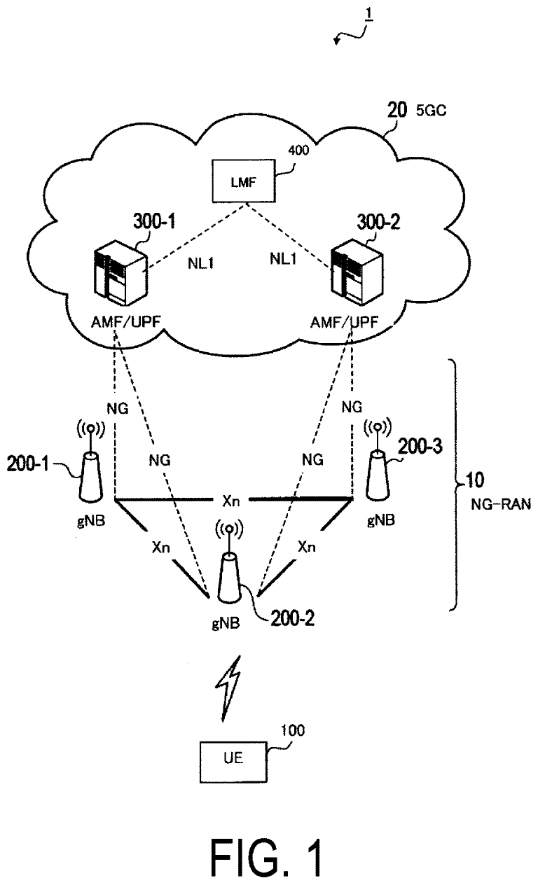

A configuration of a mobile communication system according to a first embodiment will be described. FIG. 1 is a diagram illustrating a configuration example of a mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

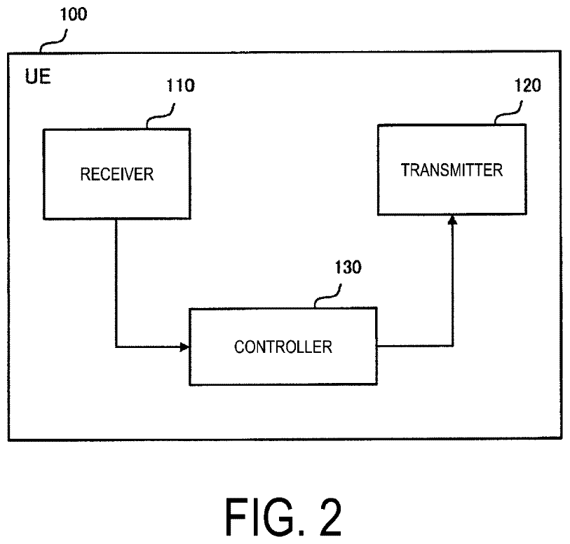

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

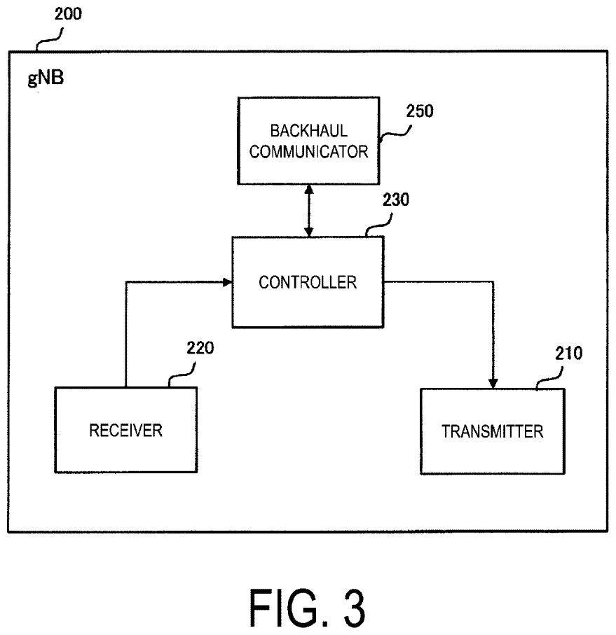

FIG. 3 is a diagram illustrating a configuration example of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

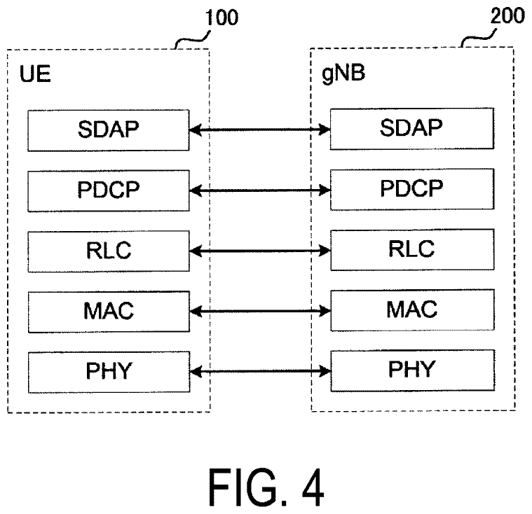

FIG. 4 is a diagram illustrating a configuration example of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. Cyclic Redundancy Code (CRC) parity bits scrambled by the RNTI are added to the DCI transmitted from the gNB 200.

In NR, the UE 100 can use a bandwidth narrower than a system bandwidth (i.e., a cell bandwidth). The gNB 200 configures a bandwidth portion (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

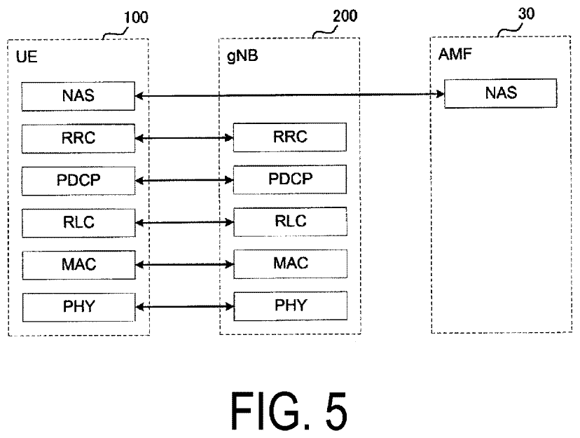

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is at a higher position than the RRC layer, performs session management, mobility management, and the like. NAS signaling is transmitted between the NAS of the UE 100 and the NAS of the AMF 300. The UE 100 includes an application layer other than the protocol of the radio interface. A layer lower than the NAS is referred to as an Access Stratum (AS).

### AI/ML Technology

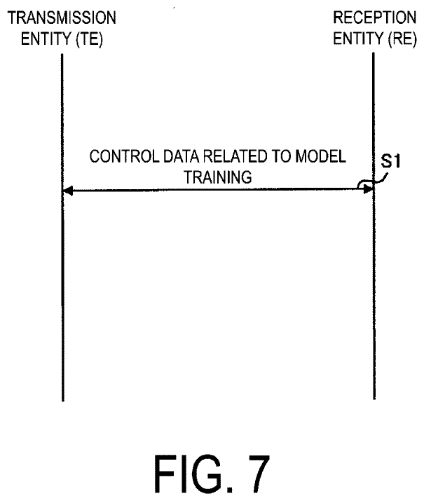

In the embodiment, an AI/ML Technology will be described. FIG. 7 is a diagram illustrating a configuration example of functional blocks of the AI/ML technology in the mobile communication system 1 according to the first embodiment.

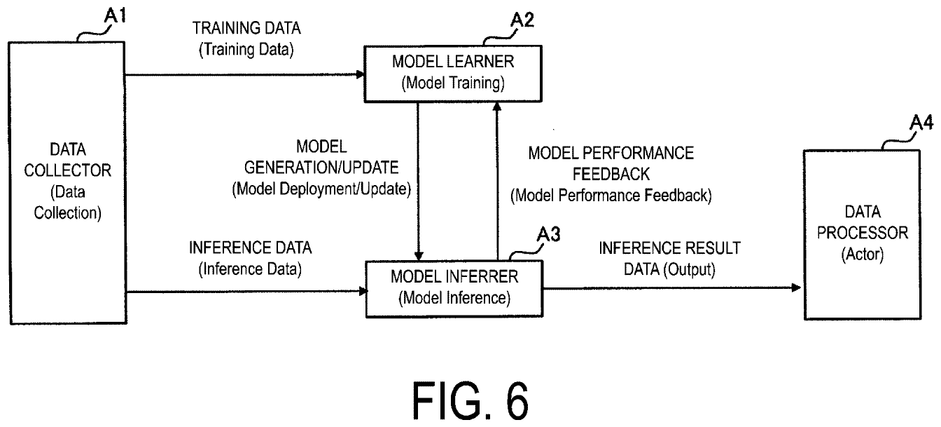

The functional block configuration example illustrated in FIG. 6 includes a data collector A1, a model learner A2, a model inferrer A3, and a data processor A4.

The data collector A1 collects input data, specifically, training data and inference data. The data collector A1 outputs the training data to the model learner A2. The data collector A1 also outputs the inference data to the model inferrer A3. The data collector A1 may acquire data in the apparatus in which the data collector A1 is provided, as input data. The data collector A1 may acquire, as the input data, data in another apparatus. Data collection refers to the process of collecting data at a network node, a management entity, or the UE 100, for example, to train AI/ML models, perform data analysis, and inference. Based on the data collected by the data collector A1, the training of the AI/ML model and the inference of the AI/ML model in the subsequent stage are performed. The “AI/ML model” is, for example, a data-driven algorithm to which an AI/ML technology is applied to generate a series of outputs based on a series of inputs. Hereinafter, the “model” and the “AI/ML model” may be used interchangeably.

The model learner A2 performs model training. Specifically, the model learner A2 optimizes parameters of the training model through machine learning using the training data, and derives (or generates, or updates) the trained model. The model learner A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although supervised learning will be described below, unsupervised learning or reinforcement learning may be applied as machine learning. In this way, the process of training an AI/ML model (by training the relationship between input and output) in a data-driven manner and acquiring a trained AI/ML model is called, for example, AI/ML model training. Hereinafter, the “AI/ML model training” may be referred to as a “model training”. The trained AI/ML model may be referred to as a “trained model”.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model learner A2. This process of using a trained AI/ML model to generate a series of outputs based on a series of inputs is called AI/ML model inference. Hereinafter, the “AI/ML model inference” may be referred to as “model inference”.

The data processor A4 receives the inference result data and performs processing that utilizes the inference result data.

FIG. 7 is a diagram illustrating an operation example in the AI/ML technology according to the first embodiment.

A transmission entity TE is, for example, an entity in which machine learning is performed. The transmission entity TE may derive a trained model by performing machine learning. The transmission entity TE uses the trained model to generate inference result data as an inference result. The transmission entity TE can transmit the inference result data to a reception entity RE.

On the other hand, the reception entity RE is, for example, an entity in which no machine learning is performed. The reception entity RE can receive the inference result data transmitted from the transmission entity TE. The reception entity RE performs various processing operations by using the inference result data. The reception entity RE may derive a trained model by performing machine learning. In this case, the reception entity RE transmits the derived trained model to the transmission entity TE.

The entity may be, for example, an apparatus. The entity may be a functional block included in the device. The entity may be, for example, a hardware block included in the device.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE 100.

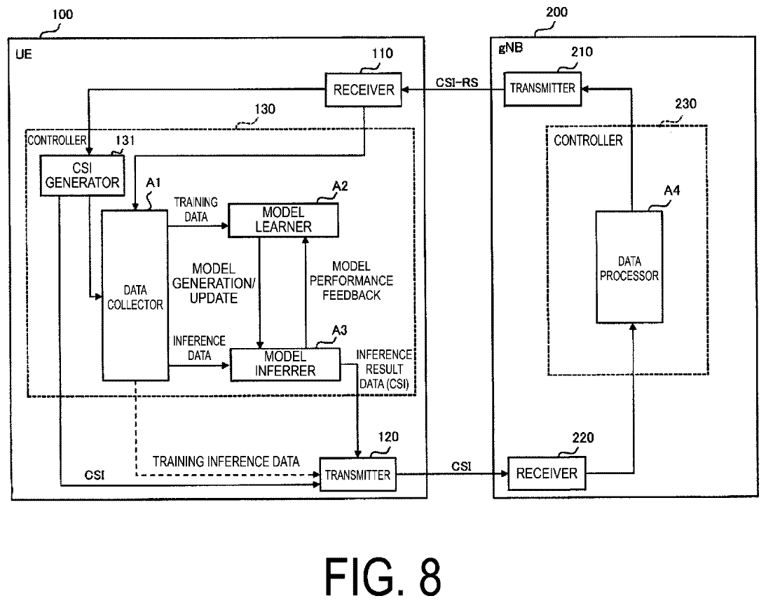

As illustrated in FIG. 8, in step S1, the transmission entity TE transmits control data regarding the AI/ML technology to the reception entity RE and receives the control data from the reception entity RE. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The downlink signaling may be broadcast signaling. The control data may be a control message in a control layer (e.g., an AI/ML layer) dedicated to artificial intelligence or machine learning.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) feedback enhancement”
(1.2) “Beam management”
(1.3) “Positioning accuracy enhancement”

Hereinafter, an arrangement example of the functional blocks will be described for each use case.

### (1.1) Arrangement Example of Functional Blocks in “CSI Feedback Enhancement”

The “CSI feedback enhancement” represents, for example, a use case where the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

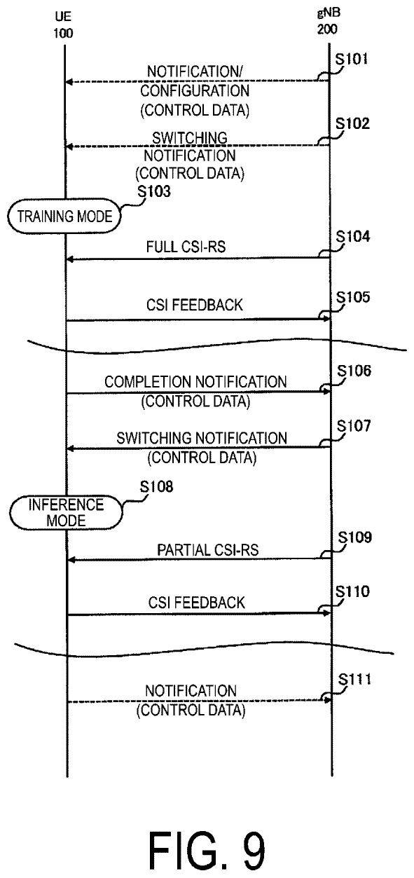

FIG. 8 is a diagram illustrating an arrangement example of the functional blocks in the “CSI feedback enhancement”. In the example of “CSI feedback enhancement” illustrated in FIG. 9, the controller 130 of the UE 100 includes the data collector A1, the model learner A2, and the model inferrer A3. On the other hand, the controller 230 of the gNB 200 includes the data processor A4. In other words, the UE 100 performs model training and model inference. FIG. 9 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model learner A2) derives a trained model for inferring CSI from the reference signal by using training data including the first reference signal and CSI. Such a first reference signal may be referred to as a full CSI-RS.

For example, a CSI generator 131 performs channel estimation by using the reception signal (CSI-RS) received by the receiver 110, and generates CSI. The transmitter 120 transmits the generated CSI to the gNB 200. The model learner A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

FIG. 9 is a diagram illustrating an operation example in the “CSI feedback enhancement” according to the first embodiment.

As illustrated in FIG. 9, in step S101, the gNB 200 may notify the UE 100 of or configure for the UE 100, as the control data, a transmission pattern (punctured pattern) of the CSI-RS in the inference mode. For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model learner A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching notification for switching the UE 100 from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back), to the gNB 200 as inference result data, the CSI, which is an inference result. The UE 100 can generate a trained model with a predetermined accuracy or higher by repeating model training in the training mode. The inference result obtained by using the trained model generated as described above is expected to have a predetermined accuracy or higher.

Note that, in step S111, upon determining that the model training is necessary, the UE 100 may transmit a notification as the control data to the gNB 200, the notification indicating that the model training is necessary.

In the description of the example illustrated in FIG. 9, the training data is “(full) CSI-RS” and “CSI”, and the inference data is “(partial) CSI-RS”. Hereinafter, the training data and/or the inference data may be referred to as a “dataset”.

In the “CSI feedback enhancement”, in addition to the “CSI-RS” and the “CSI”, for example, the following data and/or information may be used as the dataset.
(X1) Reference Signals Received Power (RSRP), Reference Signal Received Quality (RSRQ), Signal-to-interference-plus-noise ratio (SINR), or an output waveform of an AD converter (A measurement target of these data may be the CSI-RS. The measurement target may be other reception signals received from the gNB 200.)
(X2) Bit Error Rate (BER) or Block Error Rate (BLER) ((BER (or BLER) may be measured based on CSI-RS with a total number of transmission bits (or a total number of transmission blocks) being known)
(X3) Moving speed of the UE 100 (which may be measured by a speed sensor in the UE 100)
   What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits, to the UE 100 as the control data, the data type information used as a dataset. The data type information may represent, for example, any one of data or information indicated in (X1) to (X3). As the data type information, data type information used as training data and data type information used as inference data may be separately designated.

### (1.2) Arrangement Example of Functional Blocks in “Beam Management”

An arrangement example of the functional blocks in the “beam management” will be described. The “beam management” represents, for example, a use case where the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The UE 100 determines, for example, a beam with the best reception quality as the optimum beam.

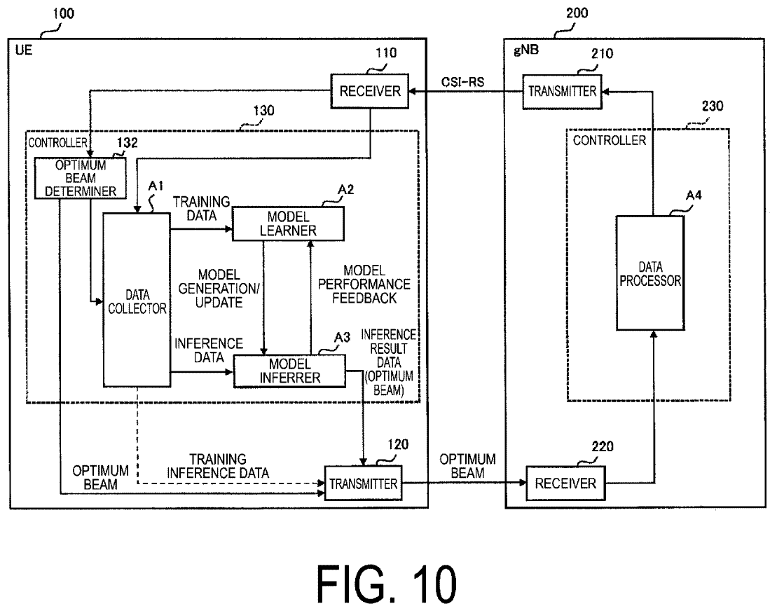

FIG. 10 is a diagram illustrating an arrangement example of the functional blocks in the “beam management”. In the example of the “beam management” illustrated in FIG. 10, the controller 130 of the UE 100 includes the data collector A1, the model learner A2, and the model inferrer A3. On the other hand, the controller 230 of the gNB 200 includes the data processor A4. In other words, FIG. 10 illustrates an example in which the UE 100 performs model training and model inference. FIG. 10 illustrates the example in which the transmission entity TE is the UE 100 and the reception entity RE is the gNB 200.

As illustrated in FIG. 10, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing the “CSI feedback” with the “optimum beam” in FIG. 10.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model learner A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, the following data and/or information may be used as the data used for the dataset.
(Y1) Synchronization Signal Block (SSB) received from the gNB 200
(Y2) RSRP, RSRQ, SINR, or the output waveform of the AD converter (a measurement target thereof may be the CSI-RS. The measurement target may be other reception signals received from the gNB 200)
(Y3) BER or BLER (BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)
   The UE 100 may transmit capability information as the control data to the gNB 200, the capability information indicating which type of input data the UE 100 can handle in the machine learning. The capability information may include any of the information or data from among (Y1) to (Y6). The capability information may include any of the information or data from among (Y1) to (Y6) aside from the training data and the inference data. The gNB 200 may transmit, to the UE 100 as the control data, the data type information used as a dataset. The data type information may include, for example, any of the data or information indicated in (Y1) to (Y6). The data type information may include any of the information or data from among (Y1) to (Y6) aside from the training data and the inference data.

### (1.3) Arrangement Example of Functional Blocks in “Positioning Accuracy Enhancement”

An arrangement example of the functional blocks in the “positioning accuracy enhancement” will be described. The “positioning accuracy enhancement” represents, for example, a use case where the accuracy of the position information measured by the UE 100 is enhanced using the machine learning technology.

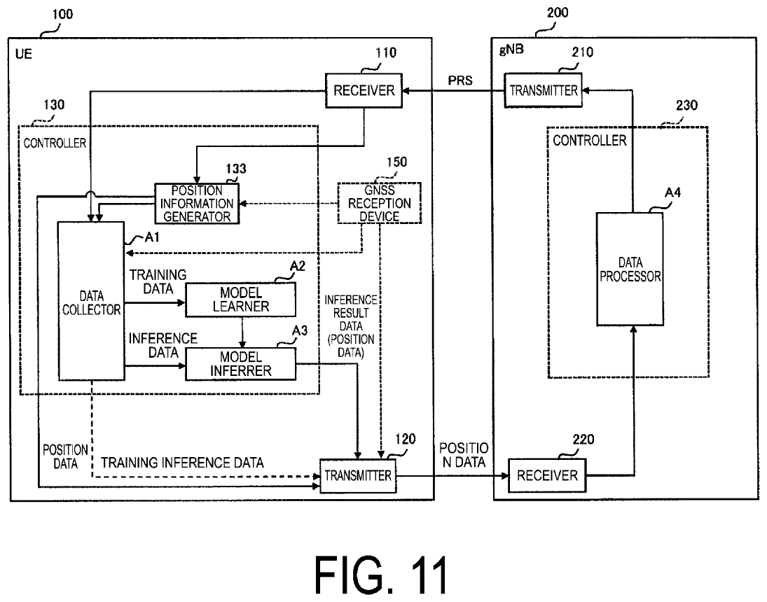

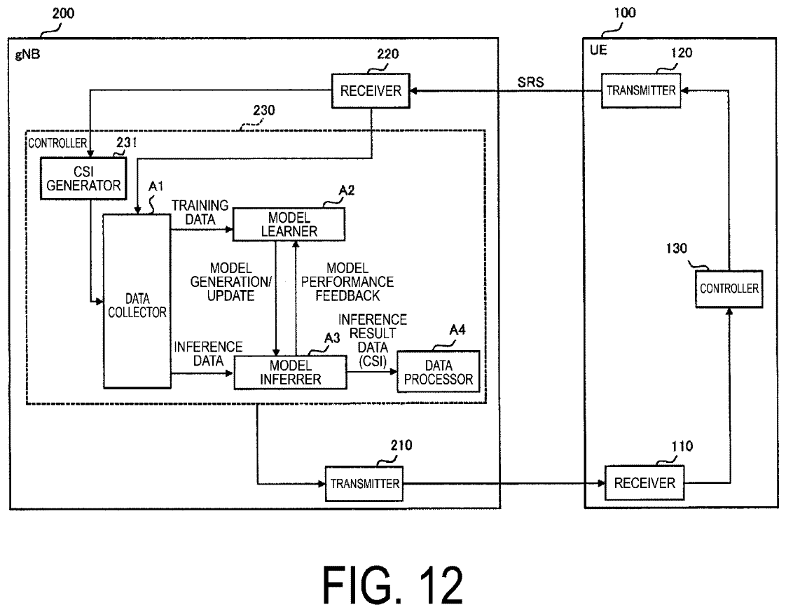

FIG. 11 is a diagram illustrating an arrangement example of the functional blocks in the “positioning accuracy enhancement”. In the example of the “positioning accuracy enhancement” illustrated in FIG. 12, the controller 130 of the UE 100 includes the data collector A1, the model learner A2, and the model inferrer A3. On the other hand, the controller 230 of the gNB 200 includes the data processor A4. In other words, FIG. 12 illustrates an example in which the UE 100 perform model training and model inference. FIG. 12 illustrates an example in which the transmission entity TE is the UE 100 and the reception entity RE is the gNB 200.

As illustrated in FIG. 11, the UE 100 includes a position information generator 133. The UE 100 may include a Global Navigation Satellite System (GNSS) reception device 150. The position information generator 133 generates position data of the UE 100 based on a Positioning Reference Signal (PRS) (full PRS or partial PRS) received from the gNB 200. The position information generator 133 may receive a GNSS signal (full GNSS signal or partial GNSS signal) received by the GNSS reception device 150 and generate the position data of the UE 100 based on the GNSS signal.

Note that, as is the case with the full CSI-RS, the gNB 200 transmits the full PRS using a predetermined amount of first resources (for example, all antenna ports or a predetermined amount of time frequency resources). As with the partial CSI-RS, the gNB 200 transmits the partial PRS by using the second resources (for example, half the antenna ports in the antenna panel or half the predetermined amount of time-frequency resources) having the smaller amount of resources than the first resources.

The full GNSS signal may be a GNSS signal temporally continuously received by the GNSS reception device 150. The partial GNSS signal may be a GNSS signal intermittently received by the GNSS reception device 150. In other words, a predetermined amount of first resources may be used for the full GNSS signal, and the second resources the amount of which is smaller than that of the first resources may be used for the partial GNSS signal.

An operation example in the “positioning accuracy enhancement” can be implemented by replacing the “full CSI-RS” with the “full PRS”, the “partial CSI-RS” with the “partial PRS”, and the “CSI feedback” with the “position data” in FIG. 10.

In the training mode (step S103), the position information generator 133 generates the position data of the UE 100 based on the full PRS received from the gNB 200. The position information generator 133 may receive a full GNSS signal received by the GNSS reception device 150 and generate the position data of the UE 100 based on the full GNSS signal. The transmitter 120 feeds back (or transmits) the position data to the gNB 200. The data collector A1 collects the full PRS (or the full GNSS signal) and the position data. The model learner A2 generates a trained model using the full PRS (or the full GNSS signal) and the position data as training data.

In the inference mode (step S108), the data collector A1 collects the partial PRS received by the receiver 110 (or the partial GNSS signal received by the GNSS reception device 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy enhancement”, in addition to the “PRS”, the “GNSS signal”, and the “position data”, for example, the following data and/or information may be used as the data used for the dataset.
(Z1) RSRP, RSRQ, Signal-to-interference-plus-noise ratio (SINR), or the output waveform of the AD converter (A measurement target of these data may be the PRS. The measurement target may be other reception signals received from the gNB 200.)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (registered trademark), or Bluetooth (registered trademark)
(Z7) Moving speed of the UE 100 (the moving speed may be measured by the GNSS reception device 150. The moving speed may be measured by a speed sensor in the UE 100)
   The UE 100 may transmit capability information as the control data to the gNB 200, the capability information indicating which type of input data the UE 100 can handle in the machine learning. The capability information may include any of the information or data from among (Z1) to (Z7). The capability information may include any of the information or data from among (Z1) to (Z7) aside from the training data and the inference data. The gNB 200 may transmit, to the UE 100 as the control data, the data type information used as a dataset. The data type information may include, for example, any of the data or information indicated in (Z1) to (Z7). The data type information may include any of the information or data from among (Z1) to (Z7) aside from the training data and the inference data.

### (1.4) Other Arrangement Examples

Other arrangement examples will be described next.

FIG. 12 is a diagram illustrating another arrangement example of the “CSI feedback enhancement” according to the first embodiment. FIG. 12 illustrates an example in which the gN 200 includes the data collector A1, the model learner A2, the model inferrer A3, and the data processor A4. In other words, FIG. 12 illustrates an example in which the gNB 200 performs model training and model inference. FIG. 12 illustrates an example in which the transmission entity TE is the gNB 200 and the reception entity RE is the UE 100.

FIG. 12 illustrates an example in which the AI/ML technology is introduced into CSI estimation performed by the gNB 200 based on a sounding reference signal (SRS). Thus, the gNB 200 includes a CSI generator 231 that generates CSI based on the SRS. The CSI is information indicating an uplink channel state between the UE 100 and the gNB 200. The gNB 200 (e.g., the data processor A4) performs, for example, uplink scheduling based on the CSI generated based on the SRS.

### (1.5) Model Transfer Example

In (1.1) to (1.4), the arrangement example of the functional blocks of the AI/ML technology has been described. Model transfer will be described below. The model to be transferred may be a trained model used in the model inference. The model may be an untrained model used in the model training (or a model being trained).

### (1.5.1) First Operation Pattern Relating to Model Transfer

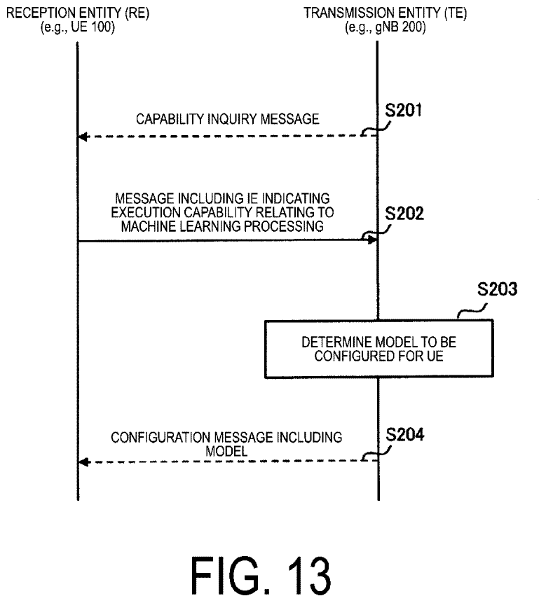

FIG. 13 is a diagram illustrating an operation example of a first operation pattern relating to model transfer according to the first embodiment. In the example illustrated in FIG. 13, the reception entity RE is mainly described as the UE 100. However, the reception entity RE may be the gNB 200 or AMF 300. In the example illustrated in FIG. 13, the transmission entity TE is mainly described as the gNB 200. However, the transmission entity TE may be the UE 100 or AMF 300.

As illustrated in FIG. 13, in step S201, the gNB 200 transmits, to the UE 100, a capability inquiry message for requesting transmission of a message including an information element (IE) indicating execution capability relating to machine learning processing. The UE 100 receives the capability inquiry message. However, the gNB 200 may transmit the capability inquiry message when performing the machine learning processing (when determining to perform the machine learning process).

In step S202, the UE 100 transmits, to the gNB 200, the message including the information element indicating the execution capability (an execution environment for the machine learning processing, from another viewpoint) relating to the machine learning processing. The gNB 200 receives the message. The message may be an RRC message, for example, a “UE Capability” message or a newly defined message (e.g., a “UE AI Capability” message or the like). Alternatively, the transmission entity TE may be the AMF 300 and the message may be a NAS message. Alternatively, when a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). The information element indicating the execution capability of the inference processing may be an information element indicating whether a deep neural network model can be supported. The information element may be an information element indicating the time (response time) required to execute the inference processing.

Alternatively, the information element indicating the execution capability relating to the machine learning processing may be an information element indicating the execution capability of the learning processing (model training). The information element indicating the execution capability of the learning processing may be an information element indicating the number of simultaneous executions of the learning processing. The information element may be an information element indicating the processing capacity of the learning processing.

In step S203, the gNB 200 determines a model to be configured (deployed) for the UE 100 based on the information element included in the message received in step S202.

In step S204, the gNB 200 transmits, to the UE 100, a message including the model determined in step S203. The UE 100 receives the message and performs the machine learning processing (that is, model training processing and/or model inference processing) using the model included in the message. A specific example of step S204 will be described in a second operation pattern below.

### (1.5.2) Second Operation Pattern Relating to Model Transfer

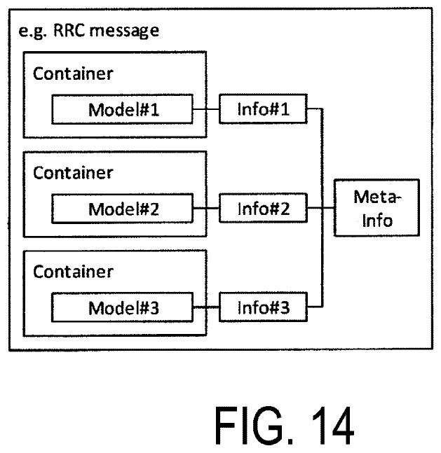

FIG. 14 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like)). Alternatively, the configuration message may be a NAS message transmitted from the AMF 300 to the UE 100. Alternatively, when a new layer for performing or controlling the machine learning processing (AI/ML processing) is defined, the message may be a message of the new layer.

In the example of FIG. 14, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

### (1.6) Configuration Example of Functional Blocks

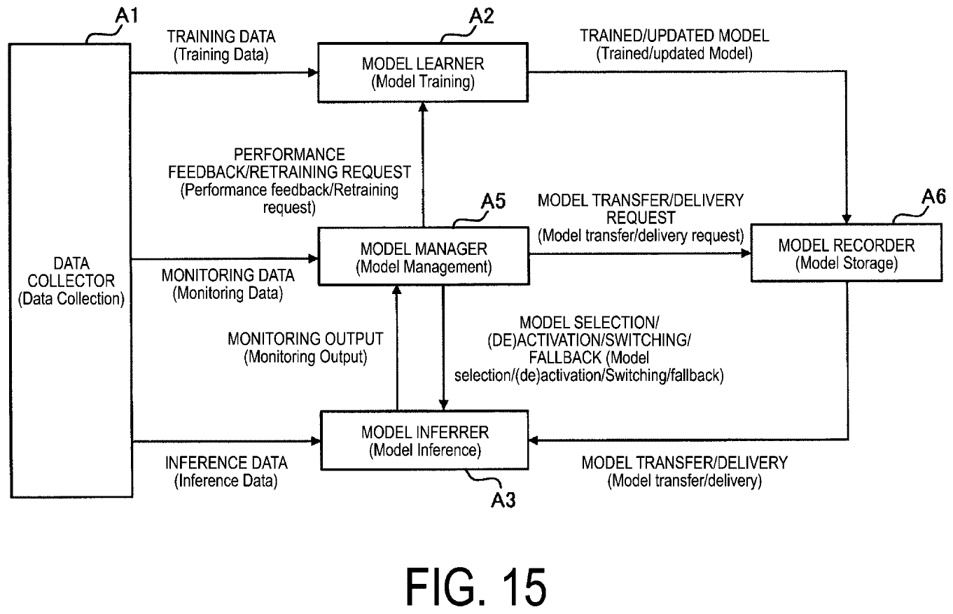

The functional blocks for AI for wireless communication have been described with reference to FIG. 7. Currently, in 3GPP, a block diagram illustrated in FIG. 15 is being studied for functional blocks of AI for wireless communication.

FIG. 15 is a diagram illustrating a configuration example of functional blocks according to the first embodiment. The functional block diagram illustrated in FIG. 15 further includes a model manager A5 and a model recorder A6, as compared with the functional block diagram illustrated in FIG. 7.

The model manager A5 manages an AI/ML model. For example, the model manager A5 requests the model learner A2 to relearn a training model, or requests the model recorder A6 to perform model transfer. As illustrated in FIG. 15, the AI/ML model that has been trained by retraining may be referred to as an updated model. For example, the model manager A5 instructs (or requests) the model inferrer A3 to perform model selection, model (de)activation, model switching, and/or fallback. The model manager A5 may evaluate the performances of trained models using the monitoring data acquired from the data collector A1 and the monitoring output acquired from the model inferrer A3, and request retraining or instruct model switching based on evaluation results.

The model recorder A6 functions as a reference point in the functional block. For this reason, the model recorder A6 does not necessarily have to record a trained model or an updated model in a recording medium.

Note that how the functional blocks illustrated in FIG. 15 are disposed in each use case is in a study stage in 3GPP.

In the following, an AI/ML model to be trained may be referred to as a “training model”, and a trained AI/ML model may be referred to as a “trained model”. Data for inference may be referred to as inference data, and data for training may be referred to as training data.

### Communication Control Method According to First Embodiment

A communication control method according to the first embodiment will be described.

As described in the use case of “positioning accuracy enhancement”, position information may be used in the AI/ML model. However, there may be a concern about position information used in the AI/ML model from the viewpoint of privacy. In 3GPP, it has been pointed out that there exists a concern about privacy of the UE 100 regarding the position information (for example, Non-Patent Document 2: RWS-230240).

Indeed, depending on the user of the UE 100, the user may not desire to use position information. For example, a user A may not desire to transmit position information of the user A's residence to a network. On the other hand, the user may consider that position information other than his or her residence may be transmitted to a network. Another user B other than the user A may consider that residence information of the user A may be transmitted.

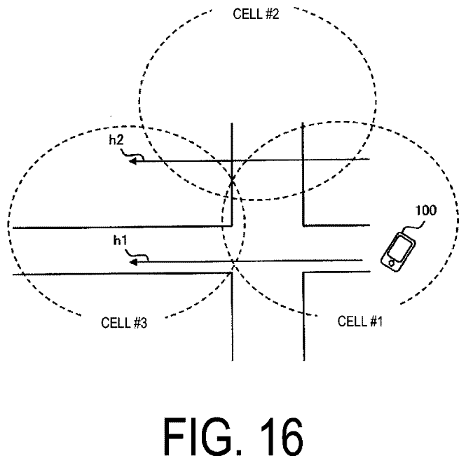

On the other hand, the network side may require the accuracy of position information or may not require the accuracy of position information. FIG. 16 is a diagram illustrating an example of a use case according to the first embodiment. As illustrated in FIG. 16, when the UE 100 is located at an intersection of roads, the accuracy of position information of the UE 100 may be required. On the other hand, when the UE 100 is located between intersections, the accuracy of the position information of the UE 100 may not be required.

That is, although there may be certainly a concern on privacy for position information, a user may permit the use of the position information or does not permit the use of the position information depending on a location (or an area) where the UE 100 is positioned.

In the first embodiment, an object is to make it possible to use position information in consideration of the privacy of a user on the network side.

For this reason, in the first embodiment, first, a base station (for example, the gNB 200) transmits a first message including a trained AI/ML model to a user equipment (for example, the UE 100). Second, the user equipment measures position information. Third, the user equipment transmits a second message including error position information, which is obtained by adding first error information indicating an error requested by the user to the position information, to the base station. Fourth, the user equipment infers second error information indicating an error with respect to the position information by using the AI/ML model, and transmits a third message including error relationship information indicating a relationship between the first error information and the second error information to the base station.

In this manner, in the first embodiment, the UE 100 transmits, to the gNB 200, error position information, which is obtained by adding an error requested by the user (for example, the first error information) to the position information. Thereby, for example, the UE 100 can transmit the position information in consideration of the privacy of the user. In the first embodiment, the UE 100 transmits, to the gNB 200, the error relationship information indicating a relationship between an error (for example, the second error information) inferred using the AI/ML model and an error requested by the user. Thereby, for example, the gNB 200 can also perform movement control on the UE 100 based on the error relationship information. Thus, even when the gNB 200 (or the network side) cannot ascertain accurate position information of the UE 100, the position information can be used in consideration of the privacy of the user.

### Operation Example According to First Embodiment

An operation example according to the first embodiment will be described.

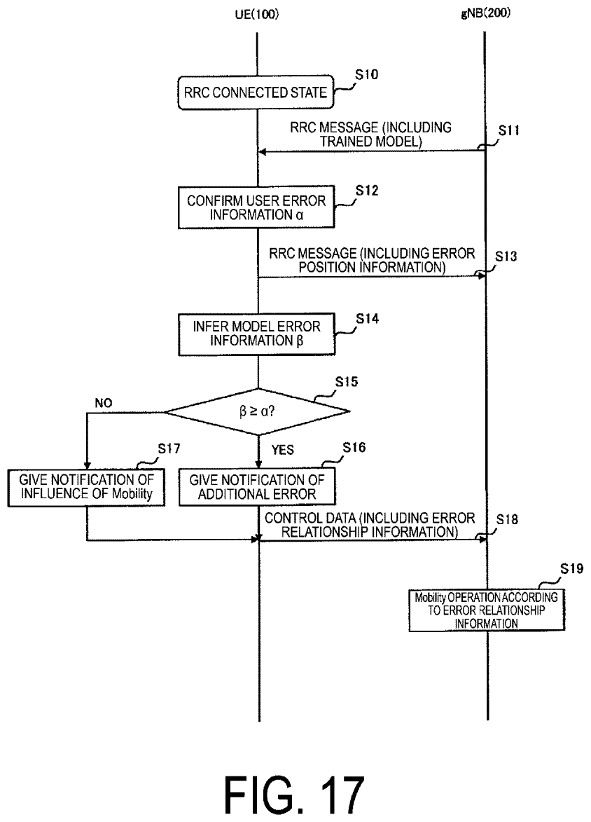

FIG. 17 illustrates an operation example according to the first embodiment.

As illustrated in FIG. 17, in step S10, the UE 100 is in an RRC connected state.

In step S11, the gNB 200 transmits, to the UE 100, an RRC message (for example, the first message) including a trained model, transmission interval information, and execution interval information. For example, the transmitter 210 of the gNB 200 transmits the RRC message. The UE 100 receives the RRC message. For example, the receiver 110 of the UE 100 receives the RRC message.

First, the trained model is an AI/ML model that receives an input of position information as inference data and outputs (or infers), as inference result data, error information (second error information) indicating an error with respect to the position information. In general, there may be a correlation between the position information and the error information for the position information. For example, in FIG. 16, it is assumed that the UE 100 acquires position information using the PRS or the GNSS reception device 150. In this case, an error (L1−L2) between an actual position L1 of the UE 100 and a position L2 indicated by the acquired position information is expected to be equal to or greater than a certain value in a situation where there exists an obstacle such as a building around an intersection, as compared to a situation where there exists no obstacle such as a building around the intersection. For example, in a situation where there exists an obstacle such as a building around the intersection, the error (L1−L2) is x1, and in a situation where there exists no obstacle such as a building around the intersection, the difference (L1−L2) is x2 (<x1). That is, the error is expected to vary depending on the actual position of the UE 100. The trained model is a model that outputs an error with respect to the actual position of the UE 100 in accordance with the position information acquired in the UE 100. The error information (for example, the second error information) output by the trained model may be referred to as “model error information” (or model error information β) below. The model error information β may be regarded as indicating a certain range. For example, when “+x” is output as the error information β from the trained model, the error information β may be regarded as indicating a range from “−x” to “+x”. The model error information β may be compared with error information α (or error allowance information) allowed (or requested) by the user, and used as a threshold value regarding whether to transmit position information from the UE 100 side to the network side (for example, the gNB 200).

Second, the transmission interval information is information indicating a transmission interval at which the UE 100 transmits the position information to the gNB 200. The UE 100 transmits the position information in accordance with the transmission interval information.

Third, the execution interval information is information indicating an execution interval of inference in the trained model (step S11). The UE 100 performs inference using the trained model in accordance with the execution interval information.

In step S12, the UE 100 confirms error information representing an error requested by the user. For example, an access layer (AS) of the UE 100 may confirm the error information in accordance with whether a notification of the error information requested by the user has been received from an upper layer higher than the access layer. The upper layer (for example, an application executed by an application program) can acquire the error information requested by the user in accordance with the user's operation of the UE 100. The error information (for example, the first error information) indicating the error requested by the user may be referred to as “user error information” (or user error information α) below. For example, the controller 130 of the UE 100 confirms the user error information α. The user error information may be confirmed before step S11. The confirmation may be performed before step S10.

In step S13, the UE 100 transmits, to the gNB 200, an RRC message (for example, a second message) including error position information obtained by adding the user error information α to the position information. The UE 100 transmits the RRC message at a timing indicated by the transmission interval information in accordance with the transmission interval information (step S11). For example, the controller 130 of the UE 100 acquires position information using the GNSS reception device 150 and adds the user error information α confirmed in step S12 to the acquired position information. The controller 130 of the UE 100 may also acquire position information from a network (for example, a location management function (LMF)) using a PRS. Since the position information transmitted by the UE 100 includes the user error information α, it is assumed that the gNB 200 cannot ascertain the accurate position of the UE 100. Thereby, the UE 100 (or the user who uses the UE 100) can transmit, to the network, the position information in consideration of privacy. When the user error information α is added to the acquired position information, the direction of the error may be fixed (for example, 180 degrees) or may be random (130 degrees, 90 degrees, or the like). For example, the transmitter 120 of the UE 100 transmits the RRC message. The gNB 200 receives the RRC message. For example, the receiver 220 of the gNB 200 receives the RRC message.

In step S14, the UE 100 acquires position information, inputs the acquired position information to the trained model (step S11), and infers the model error information β. For example, the controller 130 of the UE 100 infers the model error information β from the position information using the trained model. The UE 100 performs the inference at a timing indicated by an inference execution interval (step S11) in accordance with the inference execution interval. For example, the controller 130 of the UE 100 acquires position information using the GNSS reception device 150, and inputs the acquired position information to the trained model to obtain the model error information β at that timing. The controller 130 of the UE 100 may acquire the position information from the network using the PRS.

In step S15, the UE 100 determines whether the model error information β is equal to or greater than the user error information α. When the model error information β is equal to or greater than the user error information α (YES in step S15), the processing proceeds to step S16. On the other hand, when the model error information β is less than the user error information α (NO in step S15), the processing proceeds to step S17.

In step S16, the UE 100 notifies the user of an additional error. When the model error information β is equal to or greater than the user error information α (YES in step S15, that is, β≥α), the error inferred by the trained model is greater than the error requested by the user, and there still exists a room for an error request for the user. For this reason, for example, the access layer (AS) of the UE 100 can notify the upper layer of an additional error indicating that an error can be further added to the user error information α. Alternatively, the access layer of the UE 100 may give a change notification indicating a change to the model error information β instead of the user error information α. The upper layer may propose the additional error or the change notification to the user by displaying the additional error or the change notification on the display of the UE 100. The change to the model error information β may be a temporary change.

On the other hand, in step S17, the UE 100 notifies the user of an influence notification indicating that there exists a possibility of influencing movement control. When the model error information β is less than the user error information α (NO in step S15, that is, β<α), the user requests an error greater than the error inferred by the trained model. In this case, since the user's request for an error is excessive, the UE 100 notifies that the movement control of the UE 100 is affected by the user's request for an error. For example, in the use case illustrated in FIG. 16, the UE 100 moves from a cell #1 to a cell #3 in an actual moving route h1 of the UE 100, whereas the UE 100 moves from the cell #1 to the cell #3 via a cell #2 in a moving route h2 including the user error information α. For this reason, in the UE 100, a handover from the cell #1 to the cell #2 and a handover from the cell #2 to the cell #3 are performed, and the number of handovers is larger than the number of handovers (a handover from the cell #1 to the cell #3) performed for the actual moving route h1. In this case, information indicating that the number of handovers increases may be notified as the influence notification. For example, the access layer (AS) of the UE 100 may notify the upper layer of the influence notification. Alternatively, the access layer of the UE 100 may give the upper layer a change notification indicating a change to the model error information β instead of the user error information α. The upper layer may notify the user of the influence notification or the change notification by displaying the influence notification or the change notification on the display. The change to the model error information β may be a temporary change. The processing of step S15 to step S17 may be performed by the controller 130.

Returning back to FIG. 17, in step S18, the UE 100 transmits, to the gNB 200, control data (for example, a third message) including error relationship information indicating a relationship between the user error information α and the model error information β. The error relationship information may be information indicating that the model error information β is equal to or greater than the user error information α. The error relationship information may be information indicating that the model error information β is less than the user error information α. For example, the transmitter 120 of the UE 100 transmits the control data to the gNB 200. The gNB 200 receives the control data. For example, the receiver 220 of the gNB 200 receives the control data.

In step S19, the gNB 200 performs movement control on the UE 100 in accordance with the error relationship information. For example, in the use case of FIG. 16, in the case of the error relationship information indicating that the model error information β is equal to or greater than the user error information α, the gNB 200 transmits, to the UE 100, a handover instruction (RRC reconfiguration (RRCReconfiguration) message) from the cell #1 to the cell #3 assuming that the UE 100 moves on the moving route h1. On the other hand, in the case of error relationship information indicating that the model error information β is less than the user error information α, the handover instruction from the cell #1 to the cell #2 is transmitted to the UE 100, and then the handover instruction from the cell #2 to the cell #3 is transmitted to the UE 100.

### Another Operation Example According to First Embodiment

In the first embodiment, an example (step S11) has been described in which the gNB 200 transmits the RRC message including the transmission interval information and the execution interval information. For example, the gNB 200 may include and transmit the transmission interval information and the execution interval information in control data other than the RRC message. For example, the gNB 200 may include the trained model, the transmission interval information, and the execution interval information in a U-plane message and transmit them to the UE 100.

In the first embodiment, an example (step S13) has been described in which the UE 100 transmits the RRC message including the error position information. For example, the UE 100 may include and transmit the error position information in control data other than the RRC message.

### Other Embodiments

In the first embodiment described above, the supervised learning has mainly been described. However, the present disclosure is not limited thereto. For example, unsupervised learning or reinforcement learning may be applied to the first embodiment.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### Supplementary Notes

### Supplementary Note 1

A communication control method in a mobile communication system, the communication control method including:
transmitting, by a network node, a first message including a trained AI/ML model to a user equipment;
measuring position information by the user equipment;
transmitting, by the user equipment, a second message including error position information to the network node, the error position information being obtained by adding first error information indicating an error requested by a user to the position information; and
inferring, by the user equipment, second error information indicating an error with respect to the position information by using the AI/ML model, and transmitting, to the network node, a third message including error relationship information indicating a relationship between the first error information and the second error information.

### Supplementary Note 2

The communication control method according to Supplementary Note 1, in which
the first message further includes transmission interval information indicating a transmission interval of the position information and execution interval information indicating an execution interval of the inference using the AI/ML model,
the transmitting of the second message includes transmitting, by the user equipment, the second message in accordance with the transmission interval information, and
the transmitting of the third message includes inferring, by the user equipment, the second error information by using the AI/ML model in accordance with the execution interval information.

### Supplementary Note 3

The communication control method according to Supplementary Note 1 or 2, further including:
receiving the third message by the network node; and
performing, by the network node, movement control on the user equipment in accordance with the error relationship information.

### Supplementary Note 4

A user equipment in a mobile communication system, the user equipment including:
a receiver configured to receive a first message including a trained AI/ML model from a network node;
a controller configured to measure position information; and
a transmitter configured to transmit, to the network node, a second message including error position information obtained by adding first error information indicating an error requested by a user to the position information, in which
the controller infers second error information indicating an error with respect to the position information by using the AI/ML model, and
the transmitter transmits, to the network node, a third message including error relationship information indicating a relationship between the first error information and the second error information.

### REFERENCE SIGNS

1: Mobile communication system
20: 5GC (CN)
100: UE
110: Receiver
120: Transmitter
130: Controller
200: gNB
210: Transmitter
220: Receiver
230: Controller

1. A communication control method in a mobile communication system, the communication control method comprising:
transmitting, by a network node, a first message comprising a trained artificial intelligence (AI)/machine learning (ML) model to a user equipment;
measuring position information by the user equipment;
transmitting, by the user equipment, a second message comprising error position information to the network node, the error position information being obtained by adding first error information indicating an error requested by a user to the position information; and
inferring, by the user equipment, second error information indicating an error with respect to the position information by using the AI/ML model, and transmitting, to the network node, a third message comprising error relationship information indicating a relationship between the first error information and the second error information.

2. The communication control method according to claim 1, wherein
the first message further comprises transmission interval information indicating a transmission interval of the position information and execution interval information indicating an execution interval of the inference using the AI/ML model,
the transmitting of the second message comprises transmitting, by the user equipment, the second message in accordance with the transmission interval information, and
the transmitting of the third message comprises inferring, by the user equipment, the second error information by using the AI/ML model in accordance with the execution interval information.

3. The communication control method according to claim 1, further comprising:
receiving the third message by the network node; and
performing, by the network node, movement control on the user equipment in accordance with the error relationship information.

4. A user equipment in a mobile communication system, the user equipment comprising:
a receiver configured to receive a first message comprising a trained AI/ML model from a network node;
a controller configured to measure position information; and
a transmitter configured to transmit, to the network node, a second message comprising error position information obtained by adding first error information indicating an error requested by a user to the position information, wherein
the controller infers second error information indicating an error with respect to the position information by using the AI/ML model, and
the transmitter transmits, to the network node, a third message comprising error relationship information indicating a relationship between the first error information and the second error information.
